(19) United States
(12) Patent Application Publication
(10) Pub. No.: US 2024/0361738 A1
(43) Pub. Date: Oct. 31, 2024

(54) Operating Method for a Field Device, Computer Program Product, Field Device, Higher-Order Control Unit and Automation System

(71) Applicant: Siemens Aktiengesellschaft, Muenchen (DE)

(72) Inventors: Marco VOLZ, Karlsruhe (DE); Eric EGGERT, Wörth am Rhein (DE)

(21) Appl. No.: 18/641,635

(22) Filed: Apr. 22, 2024

(30) Foreign Application Priority Data
Apr. 28, 2023 (DE) 102023203960.5

(51) Int. Cl. G05B 15/02

(52) U.S. Cl. CPC G05B 15/02

(57) ABSTRACT

A computer program product, field device, higher-order control unit, automation system and method for operating a field device which includes a plurality of components, wherein the field device is supplied with electrical input power via an isolating amplifier, where the isolating amplifier is activated and an available electrical input power ascertained, a plurality of operating configurations having different compilation of functions of the field device is created respectively, one power requirement each is ascertained for each of the operating configurations in each case of at least one predefinable operating profile, deployable operating configurations and their associated operating profile, in which the respective power requirement is lower than the available electrical input power are ascertained and an associated function profile respectively is ascertained, and where the ascertained function profiles of the field device ascertained are provided for selection.

### BACKGROUND OF THE INVENTION

### 1. Field of the Invention

The invention relates to a method for operating a field device, a computer program product, the field device, a higher-order control unit and an automation system including the higher-order control unit.

### 2. Description of the Related Art

WO 2009/063053 A1 disclosed a method for operating a field device that is connected to an energy source. A minimum voltage requirement of the field device is ascertained here, which is the minimum required for the field device to function. In the case of an undersupply, functions can be purposefully switched off.

EP 2 507 888 B1 discloses a method for setting parameters of a field device power supply module, which pertains to a field device, which is supplied with electrical energy via a wireless adapter. Firstly, a starting voltage is provided in a start phase here and then an operating voltage is provided that is higher or lower than the starting voltage.

Field devices are being used in increasing numbers and with an increasing range of functions in automation engineering, particularly in the process industry. Appropriate configuration of the energy supply of such field devices is likewise more complex as a result.

### SUMMARY OF THE INVENTION

It is the object of the invention to provide a way to allow the energy supply of field devices to be configured more quickly, more easily and more reliably and at the same time in a way that takes advantage of the technical performance of the field device.

These and other objects and advantages are achieved in accordance with the invention by a method for operating a field device that comprises a plurality of components in order to provide a plurality of functions. The field device can be configured as an industrial automation field device. The field device can also be configured, for example, as what is known as a multi-field device that has as components a plurality of sensors, actuators, communications units and/or auxiliary units such as heating elements. A function provided by a field device can be, for example, temperature monitoring at a plurality of measuring points with a plurality of temperature sensors. The functions can be predefined, for example, by a local control unit in the field device. The field device is connected to an isolating amplifier via which the field device is provided with an electrical input power via which the components are to be supplied with power during operation. The method comprises a first step in which the isolating amplifier is activated and an electrical power present in a grid is provided to the field device as the electrical input power as a result. Moreover, in a first step, an available electrical input power is thus ascertained by the field device. The field device can be structured, for example, with a voltage measuring apparatus and/or a current measuring apparatus.

The method includes a second step in which a plurality of operating configurations is created that have a different compilation of functions of the field device, respectively. A function can be a measurement or an actuation here, which can be attained by the interaction of a plurality of components. For example, a density of a gas can be ascertained if its pressure and temperature are ascertained, and thus achieve the function of gas density measurement. An operating configuration specifies which components of the field device are necessary for the corresponding function, i.e., are to be operated. The operating configurations ascertained in the second step consequently comprise compilations of components of the field device, which are necessary for the respective functions. Furthermore, the method comprises a third step in which one power requirement each is ascertained for the operating configurations that are ascertained in the second step. The power requirement of an operating configuration is ascertained based on a predefinable operating profile. The operating profile comprises information about which functions of the field device are to be executed simultaneously and/or for what duration. The operating profile substantially comprises information about time-dependent parameters that determine the associated power requirement. The operating profiles can be defined by a user and/or artificial intelligence, which is executed, for example, in a higher-order control unit of an automation system of which the field device can be a part. Alternatively or in addition, operating profiles, which are retrieved in the third step and form the basis of ascertainment of the power requirement, can be stored in the field device.

Furthermore, the method has a fourth step in which deployable operating configurations and their associated operating profile are ascertained in which the power requirement is lower than the available electrical input power. The deployable operating configurations are combined with the associated operating profile in a fourth step to form one function profile respectively, i.e., the function profiles are ascertained. The function profiles can comprise a set of parameters with which the field device can be adjusted in order to implement the respective deployable operating configuration on the field device with the corresponding operating profile. The function profiles of the field device ascertained in the fourth step are provided for selection, moreover. The function profiles can be provided to a user and/or artificial intelligence for selection. By selecting a function profile that is made available for selection, the parameters stored therein can be applied to the field device and corresponding operation of the field device can be initiated.

The inventive method is suitable for automatically ascertaining which range of functions the field device can achieve with an available electrical input power. The method manages with a minimum number of inputs by a user and purposefully makes such function profiles available for selection, which can also be readily implemented and for which suitable parameters are preferably already present. Configuration of the field device is accelerated and simplified as a result. Furthermore, inappropriate configurations of the field device by the user are avoided. More reliable operation is guaranteed hereby even in the case of complex field devices. The inventive method makes better use of the technical potential of field devices of this kind, in particular their flexibility.

In one embodiment of the method, the power requirements are ascertained in the second step via a simulation program product. The simulation program product can be executed on the local control unit of the field device. Electrical power requirements and/or consumption characteristic curves of individual components of the field device can be stored in the simulation program product. The simulation program product can be configured to adjust a consumption of electrical energy by the field device component-wise as a function of time, i.e., also transient operating states. The simulation program product can be formed as a digital twin of the field device. The components can be linked together in the simulation program product, in particular within function profiles, via a hierarchy. The hierarchy depends on an application, i.e., an application, which is to be provided by the field device. The hierarchy can predefine to what extent individual components are necessary for the corresponding application, whether it is optional, or can be replaced by other components.

Furthermore, the predefinable operating profiles can comprise a clock variable, a display rule and/or an environment variable respectively. The clock variable can define a frequency with which a function is performed. The clock variable can be, for example, a clock rate of a sensor. The display rule can predefine, for example, whether a measured value or a warning is shown on a display. An environment variable can be an ambient temperature that determines whether the field device needs to be heated or cooled for an intended operation. An environment variable can also be information on whether the field device is being used in a potentially explosive environment, or information about the geographical location of the field device. The operating profile can thus precisely calculate an anticipated power requirement in the case of an associated operating configuration. Function profiles that can be implemented in a targeted manner can be ascertained accordingly.

In a further embodiment of the method, a first and a second function profile of the field device are ascertained. The first and second function profiles are made available for selection as predefinably alternately applicable function profiles. Accordingly, the field device can be operated with the first function profile for a first duration and with the second function profile for a second duration. For example, the first duration, the second duration and/or a duration can be predefined an inactive phase therebetween here. The field device can consequently be operated with different function profiles in a time-slice operation. The user and/or artificial intelligence can predefine the first duration, the second duration and/or the duration of the inactive phases. The user and/or artificial intelligence can also select the alternating application of the first and second function profile. In the case of operation of the field device with alternating application of the first and second function profile, components of the field device can thus be shut down in the meantime. The field device can be automatically operated in a plurality of function profiles as a result and thus a broader spectrum of functions is provided for numerous individual applications. The technical potential of the field device is thus rendered easily accessible. In a further embodiment of the method, further function profiles can also be ascertained for an alternating application and be made available for selection.

Further, a third function profile can be ascertained in the inventive method, which has a power requirement that exceeds the available electrical input power. Moreover, a differential power requirement is ascertained by which the power requirement of the third function profile exceeds the available electrical input power. The ascertained differential power requirement is output to the user and/or artificial intelligence. The third function profile can be output in a manner that differs from an output of the first and second function profiles. The user and/or artificial intelligence is consequently shown which additional electrical input power is necessary to operate the field device with the third function profile. The extent to which an energy supply of the automation system, to which the field device pertains, must be modified is quantified as a result. The inventive method thus allows the associated field device to be easily integrated in existing complex automation systems and for their theoretically existing range of functions to simultaneously be used to a greater extent.

Furthermore, power requirements of components can be ascertained by automatic activation and deactivation of the corresponding components. Similarly, components can be varyingly actuated in order to thus ascertain their power requirement in different operating states. The automatic activation and deactivation can be performed, for example, in the first step of the method. The field device can consequently also be modular, i.e., can have interchangeable components whose electrical power requirements or consumption characteristic curves are only ascertained in the field device in the fitted state. Similarly, altered electrical power requirements as a result of degradation of components can be taken into account, such as during a maintenance operation or during a reset of the automation system. The same applies to altered electrical power requirements which develop owing to corrosion, for example, on contacts.

In a further embodiment of the method, in the second step for automatically ascertained operating profiles are performed, which differ from an operating profile predefined by the user. The automatically ascertained operating profiles are ascertained by the local control unit of the field device and can be, for example, variations of the operating profile predefined by the user. The automatically ascertained operating profiles are systematically varied here in terms of their parameters. Alternatively or in addition, the parameters of the operating profile can be varied gradually from a minimum to a maximum. Varying can be performed via an algorithm, which can be executed on the local control unit. Moreover, for at least one of the automatically ascertained operating profiles, a corresponding function profile can be ascertained and made available for selection. The function profile is created here in combination with an associated operating configuration. In particular, at least one such function profile can be made available for selection, which is based on an operating profile that has a minimal deviation from the operating profile predefined by the user. The inventive method is suitable for automatically varying an operating profile requested by a user, in particular if the requested operating profile cannot be achieved with the existing electrical input power. Consequently, a function profile can be ascertained by the automatic varying of the operating profiles, which comes closest to the requested operating profile. Configuring the field device is simplified and accelerated further hereby.

Furthermore, the inventive method can comprise a fifth step which is performed during operation of the field device, in particular during a measurement operation. During operation of the field device, a function profile is applied that is ascertained and selected in the fourth step. In the fifth step, the available electrical input power is detected, i.e., monitored. With a decline in the available electrical input power, at least the third and fourth steps of the method are performed. A saving function profile is ascertained, which has a reduced range of functions compared with the function profile applied during operation. The saving function profile ascertained in the fifth step is specified to the field device as the function profile to be applied. The inventive method is thus suitable for ascertaining a saving function profile appropriate to the situation in the event of a decline in the available electrical input power. Even with reduced available electrical input power further operation is possible with the inventive method with a maximum number of functions that can still be achieved. The inventive method thereby allows better use to be made of the technical potential of the field device.

Moreover, the inventive method can be implemented independently of a data exchange between the field device and a higher-order control unit of the automation system to which the field device is indirectly or directly connected. In particular, no information relating to the type and/or version of the field device is transferred to the higher-order control unit with the method. The function profiles can thereby be ascertained independently of a transmission of an identification of type or version of the field device to the higher-order control unit. The higher-order control unit thus behaves in a field device-agnostic manner during the inventive method. Consequently, communication between the field device and the higher-order control unit can be configured to be independent of ascertainment of the function profiles in the fourth step. With the inventive method, a field device in an automation device can be adjusted with respect to the function profile before configuration of communication of the field device with the higher-order control unit. The construction of an automation system with field devices, which is configured for performing the inventive method, is simplified further as a result.

The objects and advantages are similarly achieved by an inventive computer program product. The computer program product is configured to receive and to process measured values relating to power-based variables. Moreover, the computer program product is configured to ascertain and output control commands by which a function profile of a field device can be predefined. The computer program product can be configured to be executably stored in a local control unit of the field device and/or a higher-order control unit. Inventively, the computer program product is configured to implement a method in accordance with the disclosed of embodiments. In particular, the computer program product can be configured to ascertain function profiles of the field device and make them available for selection to a user and/or artificial intelligence, which is executed on a higher-order control unit. Similarly, the computer program product can be configured to receive a corresponding selection of a function profile and to operate the field device based on this. Overall, the inventive method can be easily implemented by the inventive computer program product. During the course of an update of an existing field device, the computer program product can be configured to the device. The underlying method can be implemented on a broad range of field devices hereby.

In one embodiment of the computer program product, the product can comprise a simulation program product formed as a digital twin of the associated field device. The simulation program product can be embodied here as a digital twin within the meaning of US 2017/286572 A1, the content of which is incorporated herein by reference in its entirety. The digital twin can comprise a digital copy of the field device via which its components and their electrical modes of operation can be mapped. Moreover, the digital twin can be configured to predefinably adjust an environment of the field device with its environment variables relevant to operation of the field device, such as an ambient temperature. Operation of the field device in interaction with the environment can be adjusted hereby. Equally, operation can be adjusted based on a predefinable operating configuration, a predefinable operating profile and/or a predefinable function profile. Moreover, the digital twin can be configured to receive measured values from field device, i.e., the field device to be simulated. Based on this, it is possible, using the digital twin, to verify whether a received measured value is realistic or whether a component pertaining to the received measured value is defective. The computer program product is thus suitable for monitoring operation of the field device which corresponds to its digital twin.

The objects and advantages are similarly achieved by an inventive field device. The field device is configured to provide a plurality of functions and has for this purpose a plurality of components that can be configured, for example, as sensors, actuators and/or communications units. The field device has a local control unit upon which a computer program is executably stored. Alternatively or in addition, the field device has a data interface via which the local control unit is connected to a higher-order control unit of the corresponding automation system. The computer program product can be executably stored on the higher-order control unit here. Inventively, the computer program product is configured in accordance with the disclosed embodiments. The inventive method can be implemented via the inventive field device. An automation system can be constructed quickly and efficiently with appropriately configured field devices.

Similarly, the objects and advantages are achieved by an inventive higher-order control unit that is configured to operate an automation system, in particular in process automation. The higher-order control unit is configured to be connected to field devices via communicative data links. Executably stored on the higher-order control unit is a computer program product with which field devices connected via the communicative data links can be operated. Operation of the field devices can comprise configuring and production operation, i.e., the intended operation of the automation system. Inventively, the computer program product, which is executed on the higher-order control unit, is configured in accordance with the disclosed embodiments outlined above. The higher-order control unit can be configured, for example, as an operator station of the automation system, a host computer, a memory-programmable control, a computer Cloud or a combination of these. The underlying method can be implemented on a broad range of automation systems as a result.

Further, the objects and advantages are achieved by an inventive automation system that has a higher-order control unit. The higher-order control unit is connected to a plurality of field devices, where the field devices can be actuated and operated by the higher-order control unit. Inventively, the higher-order control unit is configured in accordance with the above-disclosed embodiments. Alternatively or in addition, at least one of the field devices of the automation system is configured in accordance with one of the above-represented embodiments. A corresponding automation system can be constructed quickly and reliably. Similarly, the automation system can be monitored easily and can thereby be operated cost-efficiently.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

The invention will be explained in more detail in figures below using individual embodiments. The figures should be understood as being mutually complementary to the extent that identical reference numerals have the same technical meaning in different figures. The features of the individual embodiments can also be combined with each other. Further, the features of the embodiments shown in the figures can be combined with the features outlined above, in detail in which:

FIG. 1 shows a schematic illustration of a first embodiment of an inventive field device upon which an embodiment of the inventive method is performed;

FIG. 2 is a schematic illustration of a second embodiment of the inventive method in one stage; and

FIG. 3 is a flowchart of the method in accordance with the invention.

### DETAILED DESCRIPTION OF THE EXEMPLARY EMBODIMENTS

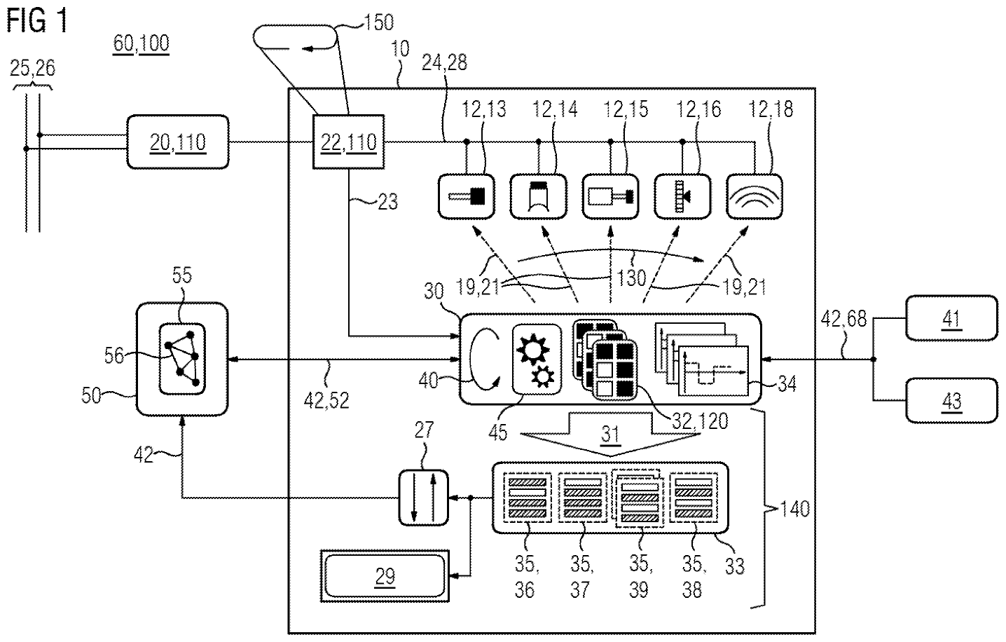

FIG. 1 schematically represents a construction of a first embodiment of the inventive field device 10 upon which an embodiment of the inventive method 100 is implemented. The field device 10 pertains to an automation system 60 (not shown) and is connected to an energy grid 25, via which electrical power 26 is provided. For this, the field device 10 is coupled via an isolating amplifier 20 to the energy grid 25 via which the field device 10 is provided with an available electrical input power 26. The isolating amplifier 20 is connected via supply lines 24 to a plurality of components 12 via which a plurality of functions of the field device 10 are provided. As components 12, the field device 10 has a temperature sensor 13, a pressure sensor 14, an actuator 15, a level sensor 16 and a communications unit 18, which are configured so as to be actuated separately by a local control unit 30. The local control unit 30 is equipped for this purpose with a computer program product 40 that is executably stored on the local control unit 30. Moreover, the local control unit 30 is connected via a communicative data link 42 to a higher-order control unit 50 with which the automation system 60 can be at least partially controlled and/or regulated. The communicative data link 42 is configured for data exchange 52 between the local control unit 40 and the higher-order control unit 50. The artificial intelligence 55 is formed as a neural net 56.

In a first step 110 of the method 100, the field device 10 is provided in a functional state and connected to the energy grid 25 via the isolating amplifier 20. The isolating amplifier 20 is activated in the first step 110 and thus an electrical power taken from the energy grid 25 is provided for the field device 10. The field device 10 has a measuring apparatus 22 that is configured to detect performance-related values. In a first step 110, an available electrical input power 28 is detected as a result and this is transferred in the form of suitable measurement signals 23 to the local control unit 30. The available electrical input power 28 corresponds to the electrical power that is available for operation of the components 12.

Moreover, the method 100 has a second step 120 in which a plurality of operating configurations 32 is created. The operating configurations 32 are represented in FIG. 1 as boxes with filled or empty fields respectively, which correspond to one component 12 respectively that is to be operated in the corresponding operating configuration 32, or not. Each operating configuration 32 thus corresponds to a compilation of components 12 of the field device 10. The operating configurations 32 can be predefined by the local control unit 30, by a user input and/or by the artificial intelligence 55 on the higher-order control unit 50.

Similarly, the inventive method 100 includes a third step 130 in which one power requirement 31 each (not shown in FIG. 1) is ascertained for the operating configurations 32. The power requirements 31 are ascertained per operating configuration 32 by taking a predefinable operating profile 34 into account. Like the operating configurations 32, the operating profiles 34 can be predefined by the local control unit 30, a user input and/or the artificial intelligence 55. The operating profiles 34 are linked for this to the operating configurations 32 respectively and the associated power requirement 31 respectively is ascertained for the paired links. The operating profiles 34 comprise information about which of the components 12 is to be operated for which duration and/or at what operating intensity. Moreover, the operating profiles 34 comprise environment variables 68 which are provided via a further communicative data link 42. The environment variables 68 include an ambient temperature, which is provided via an ambient temperature sensor 41, and location information that is provided via a position-finding apparatus 43. The ambient temperature sensor 41 and the position-finding apparatus 43 are directly connected to the field device 10, but can also alternatively be indirectly connected to the field device 10, respectively. For example, the ambient temperature sensor 41 and the position-finding apparatus 43 can be connected to the field device 10 via the higher-order control unit 50 respectively. When ascertaining the power requirements 31 in the third step 130 a plurality of operating configurations 32 is used in conjunction with a plurality of associated operating profiles 34 respectively. The operating configurations 32 are varied during the simulation performed in the third step 130. The operating configurations 32 are varied via a simulated connection 19 and disconnection 21 of individual components 12 in a simulated operation of the field device 10. The third step 130 is performed by the computer program product 40 that ascertains in this regard with a simulation program product 45 that is configured as a digital twin of the field device 10 and is coupled to or fitted with the field device 10. The simulation program product 45 is configured to adjust the electrical behavior of the components 12 and to connect and disconnect them in a simulated manner.

Further, the method 100 comprises a fourth step 140 in which the power requirements 31 ascertained in the third step 130 are evaluated further with their associated operating configurations 32 and linked operating profiles 34. In the fourth step 140, using the ascertained power requirement 31 respectively, the operating configurations 32, together with the associated operating profiles 34, are ascertained which can be provided, i.e., are functional, for the intended operation of the field device 10. The correspondingly available operating configurations 32 with their associated operating profiles 34 respectively are ascertained by comparing the respective power requirement 31 with the available electrical input power 28. In the fourth step 140, the operating configurations 32, with their associated operating profiles 34, in which the respective power requirement 31 is lower than the available electrical input power 28, are identified as being deployable. Function profiles 35 are respectively ascertained in the fourth step 140 from the operating configurations 32, with their operating profiles 34, thus identified as being deployable. The function profiles 35 are made available for selection 33 to a user and/or the artificial intelligence 55. In the fourth step 140, a first function profile 36 and a second function profile 37 are identified that are respectively capable of providing particular functions of the field device 10 for continuous operation. The range of functions of the first function profile 36 is different from the range of functions of the second function profile 37 in this case. Moreover, in the fourth step 140, an alternating application 39 of the first and second function profiles 36, 37 is also made available for selection 33. The functions of the first and second function profiles 36, 37 cannot be achieved with the available electrical input power 28. However, by way of alternating application 39 of the first and second function profiles 36, 37, it is possible to deploy their aggregated range of functions with a corresponding time restriction. With alternating application 39 of the first and second function profiles 36, 37, the field device 10 automatically changes over between these profiles. Furthermore, a third function profile 38 is ascertained in the fourth step 140 and made available for selection 33. The power requirement of the third function profile 38 exceeds the available electrical input power 28. A differential power requirement 48 (not shown in more detail in FIG. 1) is output that is necessary to deploy the third function profile 38. As a result, the user and/or the artificial intelligence 55 is provided with information as to what extent a modification of the energy grid 25 and/or of the automation system 60 is necessary to implement the third function profile 38. The selection 33 of function profiles 35 ascertained in the fourth step 140 is output for a user via a data interface 27 and/or a display apparatus 29. Starting from the data interface 27, the function profiles 35 made available for selection 33 are transferred via a communicative data link 42 to the higher-order control unit 50. Further, one of the function profiles 35 made available for selection 33 or the alternating application 39 of function profiles 35, 36, 37 is selected by the user or the artificial intelligence 55 and the field device 10 operated accordingly. Overall, the method 100 simplifies and, as a result, accelerates configuring of the field device 10. Similarly, operation with alternating application 39 of the first and second function profiles 36, 37, for example, means better use can be made of the technical potential of the field device 10. Further, the measuring apparatus 22 is configured to monitor, i.e., repeatedly detect, the available electrical input power 28 in an optional fifth step 150. The repeated detect in the fifth step 150 is symbolized in FIG. 1 by a repetition loop. The available electrical input power 28 is monitored at the same time as operation of the field device 10 and permits an automatic response to a decline in the available electrical input power.

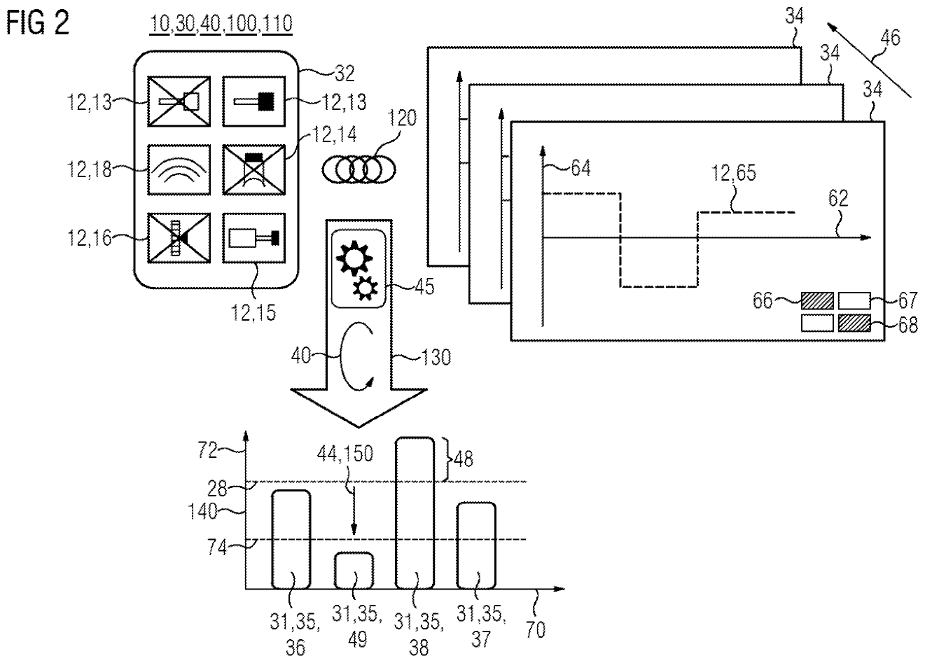

FIG. 2 schematically shows a second embodiment of the inventive method 100 during one stage of the method. The embodiment represented in FIG. 2 can be combined with the embodiment of FIG. 1. The stage of the inventive method 100 depicted in FIG. 2 assumes that the first step 110 is performed as described, for example, in FIG. 1. The stage of the method illustrated executes on a local control unit 30 of the field device 10 in a computer program product 40 executably stored thereon. In detail, the processing of one of several operating configurations 32 used in the method 100 is shown. The operating configuration 32 predefines which components 12 are connected in it, i.e., which can be used, and which cannot. One of the temperature sensors 13 of the field device 10 is connected in the operating configuration 32 shown, as shown top right, and a further temperature sensor 13 is disconnected, as represented top left. Moreover, a communications unit 18 is connected and an actuator 15 in the operating configuration 32. A pressure sensor 14 and a level sensor 16, by contrast, are disconnected. The operating configuration 32 is ascertained in the second step 120 and linked to a plurality of operating profiles 34.

An operating profile 34 is symbolized by a graph with a time axis 62 and a value axis 64. The operating profile 34 has an item of activity information 65 that shows the intensity and duration at/for which a component 12 of the field device 10 is to be operated. Moreover, the operating configuration 34 includes a display rule 67 that predefines whether a measured value linked to the corresponding component 12 is to be shown. Further, the operating profile 34 has an environment variable 68 that is significant for the power requirement 31 of the operating configuration 32 in conjunction with the operating profile 34. Furthermore, the operating profile 34 comprises a clock variable 66, which specifies how frequently the operation of the associated component 12 predefined by the item of activity information should take place. The linking of the operating configuration 32 to the operating profiles 34 respectively is symbolized in FIG. 2 by the arrow 46.

Moreover, a third step 130 is implemented in the method 100, in which a power requirement 31 is ascertained for each linking between the operating configuration 32 and one of the operating profiles 34. The respective power requirements 31 are ascertained by simulating the operation of the field device 10 while applying the operating configuration 32 in the respective linking to one of the operating profiles 34. The power requirements 31 per simulation are ascertained via a simulation program product 45 that is configured as a digital twin of the field device 10 that is coupled to the computer program product 40 or pertains to it. The second step 120 represented in FIG. 2 is also implemented for a plurality of operating configurations 32 that are not shown.

The power requirements 31 ascertained in the third step 130 are processed further in a fourth step 140. In the fourth step 140, the power requirements 31 are compared with an available electrical input power 28 ascertained in the first step 110. The comparison of the fourth step 140 is represented in a graph 70 with a power axis 72. A function profile 35 is ascertained for the power requirements 31 based on the associated operating configuration 32 respectively and the operating profile 34 linked thereto. The function profile 35 provides summary information as to which functions can be deployed by the field device 10. A first function profile 26 and a second function profile 37 are ascertained whose respective power requirement 31 is lower than the available electrical input power 28. A third function profile 38 is similarly ascertained whose power requirement 31 exceeds the available input power 28. On this basis, a power requirement difference 48 is ascertained that is output to a user and/or artificial intelligence 55 that is executed in a higher-order control unit 50. The function profiles 35, 36, 37, 38 are provided to the user and/or the artificial intelligence 55 for selection 33.

Moreover, the first or second function profile 36, 37 is selected and the field device 10 operated based on this. During operation of the field device 10, a fifth step 150 of the method 100 follows if a decline 44 in the available electrical input power 28 to a reduced electrical input power 74 occurs. In the fifth step 150, the decline 44 is detected and at least the third and fourth steps 130, 140 of the method 100 are performed again. The reduced electrical input power 74 is used as a new value for the available electrical input power 28. Consequently, a saving function profile 49 is ascertained in the fifth step 150, analogously to the first or second function profile 36, 37, the power requirement 31 of which saving function profile undershoots the reduced electrical input power 74. Further, the saving function profile 74 is automatically applied to the field device 10 in the fifth step 150. As a result, the field device 10 switches to operation with a reduced range of functions compared to the previously applied first or second function profile 36, 37. Due to the fifth step 150, the local control unit 30, and therewith also the field device 10, is capable of reacting flexibly and appropriately to the decline 44 in the available electrical input power 38. As a result, operation with a maximum number of functions that can still be deployed is possible even with the existence of reduced electrical input power 74. As a result, the technical potential of the field device 10 is also optimally exploited in adverse operating situations.

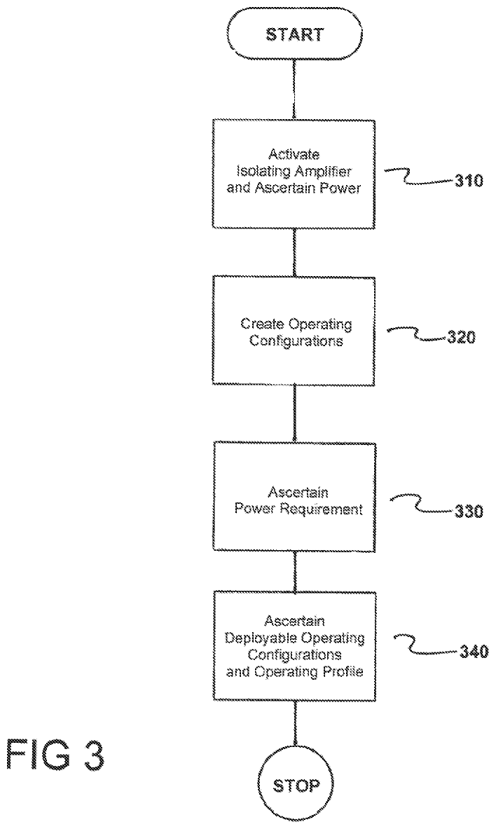

FIG. 3 is a flowchart of the method 100 for operating a field device 10 which, for deploying a plurality of functions, comprises a plurality of components 12, 13, 14, 15, 16, 18, where the field device 10 is supplied with an electrical input power 26 via an isolating amplifier 20.

The method comprises a) activating the isolating amplifier 20 and ascertaining an available electrical input power 28, as indicated in step 310.

Next, b) a plurality of operating configurations 32 having a different compilation of functions of the field device 10 respectively are created, as indicated in step 320.

Next, c) one power requirement 31 each for the operating configurations 32 is ascertained from step b) in each case of at least one predefinable operating profile 34, as indicated in step 330.

Next, d) deployable operating configurations 32 and operating profile 34 associated with each deployable operating configuration 32, in which a respective power requirement 31 is lower than the available electrical input power 28 are ascertained and an associated function profile 35, 36, 37, 38 are respectively ascertained, as indicated in step 340.

In accordance with the method, the function profiles 35, 36, 37, 38 of the field device 10 ascertained in step 340 are provided for selection 33.

Thus, while there have been shown, described and pointed out fundamental novel features of the invention as applied to a preferred embodiment thereof, it will be understood that various omissions and substitutions and changes in the form and details of the methods described and the devices illustrated, and in their operation, may be made by those skilled in the art without departing from the spirit of the invention. For example, it is expressly intended that all combinations of those elements and/or method steps that perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

What is claimed is:

1. A method for operating a field device which, for deploying a plurality of functions, comprises a plurality of components, the field device being supplied with an electrical input power via an isolating amplifier, the method comprising:
a) activating the isolating amplifier and ascertaining an available electrical input power;
b) creating a plurality of operating configurations having a different compilation of functions of the field device, respectively;
c) ascertaining one power requirement each for the operating configurations from step b) in each case of at least one predefinable operating profile;
d) ascertaining deployable operating configurations and operating profile associated with each deployable operating configuration, in which a respective power requirement is lower than the available electrical input power and ascertaining an associated function profile, respectively;
wherein the function profiles of the field device ascertained in step d) are provided for selection.

2. The method as claimed in claim 1, wherein the power requirements are ascertained in step b) via a simulation program product.

3. The method as claimed in claim 1, wherein the predefinable operating profiles comprise at least one of a clock variable, a display rule and an environment variable respectively.

4. The method as claimed in claim 2, wherein the predefinable operating profiles comprise at least one of a clock variable, a display rule and an environment variable (68) respectively.

5. The method as claimed in claim 1, wherein a first and a second function profile of the field device are ascertained and a predefinably alternating application of the first and second function profiles is made available for selection.

6. The method as claimed in claim 1, wherein a third function profile is ascertained which has a power requirement which exceeds the available electrical input power; and wherein a differential power requirement is ascertained and shown to the user.

7. The method as claimed in claim 1, wherein power requirements of components are ascertained by automatic separate activation and deactivation of components.

8. The method as claimed in claim 1, wherein step b) is performed for automatically ascertained operating profiles which differ from an operating profile predefined by the user, and for at least one automatically ascertained operating profile, a corresponding function profile is made available for selection.

9. The method as claimed in claim 1, wherein during operation of the field device, the available electrical input power is detected in a further step e) and with a decline in the available electrical input power, at least steps c) and d) are performed and at least one saving function profile is ascertained as the function profile to be applied.

10. The method as claimed in claim 1, wherein the method is performed independently of a data exchange between the field device and a higher-order control unit of an associated automation system.

11. A computer program product which is configured for receiving and processing measured values of power-based electrical values and which is configured to ascertain and output control commands via which a function profile of a field device is predefinable, wherein the computer program product is configured to perform the method as claimed in claim 1.

12. The computer program product as claimed in claim 11, wherein the computer program product comprises a simulation program product of the associated field device configured as a digital twin.

13. A field device comprising:
a plurality of separately operable components, via which a plurality of functions of the field device are deployable; and
a local control unit upon which a computer program product for operating the field device is executably stored; and
a data interface for a higher-order control unit upon which a further computer program product for operating the field device is executably stored;
wherein the computer program product is configured as claimed in claim 11.

14. A field device comprising:
a plurality of separately operable components, via which a plurality of functions of the field device are deployable; and
a local control unit upon which a computer program product for operating the field device is executably stored; and
a data interface for a higher-order control unit upon which a further computer program product for operating the field device is executably stored;
wherein the computer program product is configured as claimed in claim 12.

15. A higher-order control unit for an automation system which is connectable to a plurality of field devices via communicative data links, wherein a computer program product for operating at least one of the field devices is executably stored on the higher-order control unit, wherein the computer program product is configured as claimed in claim 11.

16. A higher-order control unit for an automation system which is connectable to a plurality of field devices via communicative data links, wherein a computer program product for operating at least one of the field devices is executably stored on the higher-order control unit, wherein the computer program product is configured as claimed in claim 12.

17. An automation system comprising a higher-order control unit, which is connected to a plurality of field devices, wherein at least one of field device of the plurality of field devices and the higher-order control unit is configured as claimed in claim 15.
